(19) United States
(12) Patent Application Publication
(10) Pub. No.: US 2012/0019907 A1
(43) Pub. Date: Jan. 26, 2012

(54) HIGH-RESOLUTION SURFACE PLASMON MICROSCOPE THAT INCLUDES A HETERODYNE FIBER INTERFEROMETER

(75) Inventors: Francoise Argoul, Lyon (FR); Lofti Berguiga, Lyon (FR); Audrey Fahys, Lyon (FR)

(73) Assignees: CENTRE NATIONAL DE LA RECHERCHE SCIENTIFIQUE, Paris Cedix 16 (FR); ECOLE NORMALE SUPERIEURE DE LYON, Lyon Cedex 07 (FR)

(21) Appl. No.: 13/147,464

(22) PCT Filed: Feb. 11, 2010
(86) PCT No.: PCT/FR2010/050227

§ 371 Date: Sep. 29, 2011

(30) Foreign Application Priority Data
Feb. 12, 2009 (FR) 0950878

(51) Int. Cl. G02B 21/00

(52) U.S. Cl. 359/371; 359/370

(57) ABSTRACT

The present invention relates to a high-resolution surface plasmon microscope including a heterodyne interferometer (6) for splitting an excitation light beam into at least one reference beam and at least one measurement beam directed toward a coupling medium (7) to generate a surface plasmon, said heterodyne interferometer consists essentially of guide optical fibers (12, 13, 14, 15) optically connected at a first of their ends to an optical coupler (16) and each also optically connected at their second end to a light source (1), an optical coupling medium (7), an element (17) for reflecting the reference beam, and means (28) for detecting an interferometer beam, respectively.

### TECHNICAL FIELD OF THE INVENTION

The present invention relates to a high-resolution surface plasmon microscope including a fiber-optic heterodyne interferometer, i.e. an interferometer consisting essentially of optical fibers.

The technical field of the invention is that of designing imaging systems and methods for detecting small refractive index variations in an observation medium and/or dielectric objects with a size of the order of a few nanometers not necessarily having noteworthy optical properties (fluorescence, luminescence, localized plasmonic resonance, or Raman resonance), located close to a surface and immersed in a dielectric medium, notably in air or an aqueous medium.

### PRIOR ART

A surface plasmon is a surface electromagnetic wave that propagates in an interface between a metal and an observation dielectric medium.

Excitation of the surface plasmon requires polarized incident light and a coupling medium with a metal/dielectric medium interface at a particular angle θₚ that is usually called the plasmon resonance angle.

By virtue of the resonance properties of surface plasmons, the angle θₚ (i.e. the coupling condition) is highly sensitive to the slightest modification of the optical properties of the metal/dielectric medium interface. This sensitivity renders the surface plasmon usable for the production of images of objects of very small size situated at the metal/dielectric medium interface, said objects modifying the optical properties of the surface plasmon at that interface, which enables contrast to be obtained between the object and its medium.

The surface plasmon being an evanescent wave, it further circumvents volume effects within the observation medium.

Various surface plasmon microscope configurations have already been proposed in the prior art. Many of them rely on the principle of excitation of the plasmon in the so-called Kretschmann-Raether configuration. However, the resolution of those systems, which is limited by lateral propagation of the plasmon, is relatively low, of the order of only a few tens of micrometers at visible wavelengths.

More recently, new generations of surface plasmon microscopes have been proposed in which resolution is no longer limited by lateral propagation of the plasmon, but only by diffraction.

Those various microscopes all share the concept of focusing a laser beam with an objective lens of high numerical aperture and high magnification on a surface that features a metal (gold, silver, copper, aluminum, etc.) layer a few tens of nanometers thick. That enables simultaneous excitation and confinement of the surface plasmon.

Those techniques may nevertheless be distinguished firstly by the illumination profile at the entry of the objective lens and secondly by the mode of detecting the signal.

When a beam reaches the entry of the objective lens of the microscope, only a very narrow ring of light contributes to excitation of the surface plasmon. The part of the reflected beam that contains information relating to the surface plasmon is very narrow and is buried within the rest of the light beam. Without special processing of the beam, imaging is virtually impossible.

In some publications, notably in Japanese patent application JP 2003 083886, illumination and detection rely on spatial filtering at the entry of the objective lens of the light rays that contribute to plasmon excitation and eliminating those that do not contribute thereto.

Some other publications, such as American patents U.S. Pat. No. 6,970,249 and US 2004/0100636 and the papers by M. G. Somekh, S. G. Liu, T. S. Velinov and C. W. See, “Optical V(z) for high-resolution plasmon microscopy”, Optics Letters 25, 823 (2000) and “High-resolution scanning surface-plasmon microscopy”, Applied Optics 39, 6279 (2000), propose using an interferometer. Although more costly to implement, that method achieves greater sensitivity. However, in the optical configuration described, only a fraction of the incident light energy participates in excitation of the surface plasmon. Moreover, the image stability and sensitivity as obtained using these techniques are limited and generally unsatisfactory for viewing objects of very small size, in particular sizes of the order of a few tens of nanometers, as may apply in biology.

Moreover, other microscopy techniques such as optical coherence tomography (OCT) microscopy as described in the document US 2004/100636 can neither rectify those insufficiencies nor be combined with current surface plasmon technologies given that the nature of the observed light beams is different, in particular in terms of amplitude and phase distribution, which are not homogeneous with the surface plasmon, and which therefore cannot be observed in OCT microscopy, which relies on the observation of beams of light in which amplitude and phase variations are uniform.

An object of the present invention is to provide a high-resolution surface plasmon microscope that has increased resolution and sensitivity compared to existing surface plasmon microscopes.

Another object of the invention is to provide a surface plasmon microscope that improves observation stability and enhances the light beam for excitation and observation of the surface plasmon.

A further object of the invention is to provide a surface plasmon microscope that enables observation of molecules and particles in aqueous dielectric media, and in particular in biological liquids.

The invention aims in particular to provide a high-resolution surface plasmon microscope enabling detection and viewing of objects of very small size, i.e. with sizes of the order of one nanometer, such as biological molecules, for example, without recourse to chemical, optical or radioactive marking of the objects.

A final object of the invention is to provide a surface plasmon microscope that is compact and simple to use and is also suited to a biological or medical laboratory environment.

### SUMMARY OF THE INVENTION

The above objectives are achieved by the present invention through a high-resolution surface plasmon microscope essentially including:

a) a coherent light source adapted to emit an excitation light beam;

b) a medium for optical coupling and confinement of a surface plasmon, including an objective lens of large numerical aperture, immersion oil, and a glass plate covered on a face that is not in contact with the immersion oil with a metal layer;

c) a heterodyne interferometer for splitting the excitation light beam emitted by the light source into at least one reference beam and at least one measurement beam directed toward the optical coupling medium to generate a surface plasmon, the interferometer being positioned between the light source and the objective lens of the optical coupling medium to form an interferometer beam between the reference beam and the measurement beam after reflection of each of them by the reflecting element and the metal layer, respectively;

d) means for scanning the metal layer with the measurement light beam;

e) means for detecting the interferometer beam from the interferometer; and

f) means for processing and forming an image from the interferometer beam.

According to the invention the heterodyne interferometer of the microscope consists essentially of at least four optical fibers for respectively guiding the excitation beam, the measurement beam, the reference beam, and the interferometer beam optically connected at a first of their ends to an optical coupler and each also optically coupled at their second end to the light source, the optical coupling medium, the element for reflecting the reference beam, and the means for detecting the interferometer beam, respectively.

Here the first ends of the optical fibers of the interferometer are the ends of the fibers connected to the optical coupler and their second ends are the ends of the fibers connected to another element of the microscope distinct from the optical coupler.

The microscope of the invention enables detection of dielectric and metal objects with a diameter less than 10 nanometers (nm) without marking said objects.

It has the advantage, compared to known surface plasmon microscopes, of greatly reducing the overall size of the microscope and optical adjustments thereof, since it enables elimination of all mechanical supports for the optical elements of the interferometer.

Moreover, the microscope of the invention greatly and significantly improves the stability of the interferometer and the quality of the light beams employed, meaning the measurement and reference beams and the interferometer beam, which enables greatly improved sensitivity and image quality.

According to the invention, the optical fibers of the heterodyne interferometer may be monomode or multimode fibers. In practice, the choice of fibers depends on stability and sensitivity criteria defined by the user. In a microscope of one preferred embodiment of the invention the optical fibers are polarization-maintaining fibers at the wavelength of the excitation light beam emitted by the source.

According to the invention, the coupler for connecting the optical fibers of the interferometer is adapted to the properties of the optical fibers used.

According to the invention, the optical fibers the second ends of which are respectively connected to the element for reflecting the reference beam and to the medium for coupling and confining the surface plasmon each cooperate with at least one acousto-optical modulator.

In the microscope of a preferred embodiment of the invention, the optical fiber for guiding the excitation light beam is connected at its second end to the light source via at least one collimator lens.

In this preferred embodiment, the microscope of the invention advantageously also includes an optical isolator and a half-wave plate disposed between the light source and the collimator lens.

In this preferred embodiment, the microscope of the invention advantageously also includes a polarization converter positioned between the half-wave plate and the collimator lens. This polarization converter makes it possible to vary at will, and where appropriate periodically, the linear, circular, radial, or azimuth polarization of the excitation light beam, for example.

The polarization conversion effected by the polarization converter has the particular advantage of enabling an image to be produced in differential mode, which enables further improvement of the contrast and dynamic range of the images obtained. It is then possible to use the polarization converter to polarize the excitation beam alternately in pure p (radial polarization) mode and in pure s (azimuth polarization) mode and to scan with the measurement beam alternately polarized in pure p mode and in pure s mode the metal layer linearly, alternately, and synchronously with the alternating polarization of the excitation beam.

The fiber for guiding the measurement beam is advantageously connected at its second end to the optical coupling medium via a collimator lens that collimates the measurement beam onto the objective lens of the coupling medium.

In the microscope of one particular embodiment of the invention, the element for reflecting the reference beam is a mirror. This mirror preferably and advantageously consists of a metal coating deposited on the end of the fiber for guiding the reference beam.

In another particular embodiment, the element for reflecting the reference beam consists of the glass plate of an optical coupling medium identical to the optical coupling medium connected to the fiber for guiding the measurement beam, said plate being coated on a face not in contact with the immersion oil with a metal layer of the same quality as that coating the glass plate of the optical coupling medium connected to the fiber for guiding the measurement beam.

The microscope of this particular embodiment of the invention advantageously enables imaging by producing surface plasmon interference between the reflected beam generated by the measurement beam and the reflected beam generated by the reference beam.

In the microscope of a different embodiment of the invention, the objective lens of the optical coupling medium to which the fiber for guiding the measurement beam is connected is replaced by a solid immersion lens and the collimator lens for the measurement beam is integrated with the second end of the fiber for guiding the measurement beam, by assembly or in the form of a lensed fiber.

In another embodiment, the collimator lens connecting the fiber for guiding the measurement beam to the optical coupling medium and the objective lens of the optical coupling medium are both replaced by an axicon formed directly at the second end of said fiber for guiding the reference beam.

According to another advantageous feature of the microscope of the invention, the microscope includes a system for scanning the metal surface of the optical coupling medium with the measurement beam.

Finally, the microscope of one embodiment of the invention may include a polarizer between the means for detecting the interferometer beam and the second end of the fiber for guiding said interferometer beam, in particular to increase image contrast in the linear polarization configuration.

### DESCRIPTION OF THE DRAWINGS

Other features and advantages of the microscope of the invention become clear on reading the following detailed description, which is given with reference to the appended drawings, in which:

FIG. 1 represents a surface plasmon microscope of a first preferred embodiment of the present invention;

FIG. 2 is a diagram of the response V(z) of the microscope of the invention in the FIG. 1 configuration;

FIG. 3 represents an alternative embodiment of the optical coupling medium of the microscope, including a lens doublet fixed to an optical fiber;

FIG. 4 represents diagrammatically the microscope of a first variant of the invention; and

FIG. 5 represents the microscope of a second variant of the invention suitable for plasmon interference microscopy.

### DETAILED DESCRIPTION OF EMBODIMENTS OF THE INVENTION

The present invention proposes a new high-resolution surface plasmon microscope configuration for the observation in air and in aqueous media of nanoparticles and molecules with no fluorescent markers. In this configuration, the microscope includes a heterodyne interferometer consisting essentially of optical fibers, which is novel.

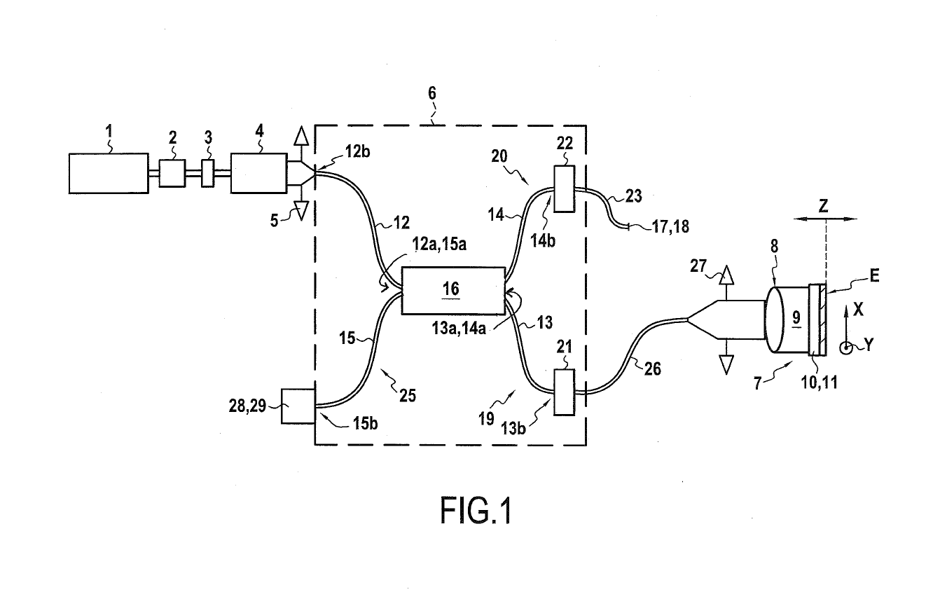

Referring first to FIG. 1, the microscope of the present invention firstly includes a coherent light source 1, that chosen in the particular example shown being an amplitude-stabilized polarized helium-neon monomode laser. This light source is not limiting on the invention, however, and the use of other types of coherent light source may be envisaged.

The light source 1 emits a laser beam for exciting a surface plasmon that is injected and directed via a heterodyne interferometer 6 into an optical coupling medium 7 including, in the FIG. 1 example and in a standard manner for a surface plasmon microscope, an objective lens 8 with a high numerical aperture, immersion oil 9, and a glass plate 10 covered with a fine layer 11 of metal, preferably gold, at which level a surface plasmon is generated by the excitation laser beam.

As shown in FIG. 1, the heterodyne interferometer 6 of the microscope of the invention consists essentially of at least four optical fibers 12, 13, 14, 15 optically interconnected at one end 12a, 13a, 14a, 15a by an optical coupler 16. These optical fibers 12, 13, 14, 15 are preferably polarization-maintaining monomode fibers.

In the context of the invention, the polarization-maintaining optical fibers 12, 13, 14, 15 of the interferometer are monomode fibers at the wavelength of the excitation laser beam produced by the source 1; in other words, light propagates in these optical fibers in a single guided mode.

A first optical fiber 12 is for guiding the excitation beam. This beam is injected into the guide fiber 12 at the second end 12b of the fiber via a collimator lens 5. Between this collimator lens 5 and the light source 1, the excitation beam emitted by said source passes through an optical isolator 2, a half-wave plate 3, and a polarization converter 4.

The function of the optical isolator 2 is to prevent the phenomenon of beam return linked to the interferometer 6, which behaves like a mirror and destabilizes the laser. The half-wave plate 3 controls the orientation of the polarization of the excitation beam, the polarization converter 4 generating a selected polarization of the excitation beam before its entry into the guide fiber 12, for example linear, circular, radial, or azimuthal polarization.

The guide fiber 12 is welded at its end 12a to the optical coupler 16. This coupler 16 is of the polarization-maintaining type. It splits the excitation beam guided by the fiber 12 from the light source 1 into identical measurement and reference beams, the measurement beam being transmitted and guided in a second guide optical fiber 13 to the optical coupling medium of the microscope and the reference beam being transmitted and guided by a third optical fiber 14 to a reflecting element 17, this reflecting element being a mirror 18 in this embodiment.

The optical fibers 13, 14 respectively form a measurement arm 19 and a reference arm 20 of the heterodyne interferometer 6. These two arms, and thus the two fibers 13, 14, are each connected to an acousto-optical modulator 21, 22 that shifts the optical frequency of the light beam transmitted by each fiber 13, 14 by a frequency Ωref and Ωtest.

The acousto-optical modulator 22 of the reference arm 20 is connected to a polarization-maintaining optical fiber 23 the end 24 of which is covered by a metal deposit providing the mirror 18. Light transmitted in this arm 20, the frequency of which has been shifted by Ωref, is reflected by this mirror 18 and returns via the acousto-optical modulator 22, the optical fiber 14, and the coupler 16, and is then coupled into a fourth arm 25 of the interferometer 6 formed by a fourth optical fiber 15. It undergoes a total frequency shift of 2 Ωref.

In the measurement arm 19, the optical fiber 13 is connected to an acousto-optical modulator 21 which shifts the optical frequency of the transmitted light by a frequency Ωtest. The acousto-optical modulator 21 is connected to a polarization-maintaining optical fiber 26 at the exit from which the light, which is in fact the excitation beam, is collimated by a collimator lens 28 onto the high numerical aperture objective lens of the optical coupling medium of the microscope to illuminate the glass plate on which a sample E is placed for observation.

The light of the excitation beam transmitted by the objective lens 8 is reflected by the optical system 10, 11, E, passes again through the objective lens 8, and returns to the lens 27, which focuses the light at the exit from the optical fiber 26 to enable its reinjection into it. The light is again frequency shifted by Ωtest at the exit from the acoustical modulator 21. After passing through the optical fiber 13 and the coupler 16, the reflected light is transmitted in the fourth arm 25 of the heterodyne interferometer 6 with the reflected beam from the reference arm. It undergoes an overall frequency shift of 2 Ωtest. Thus the light field that propagates in the fourth arm 25 of the interferometer consists of the superposed reflected beams coming from the reference arm and the measurement arm.

At the end 15b of the fiber 15 forming the fourth arm 25, where there is a photosensitive detector 28, the luminous power has a continuous component and a component modulated in time at the frequency

fm=2(Ωtest−Ωref)=2ΔΩ.

If the initial excitation beam is linearly polarized, a polarizer 29 may be added at the entry of the detector 28.

The microscope of the invention represented in FIG. 1 and described above has many advantages compared to known surface plasmon microscopes.

In particular, the microscope of the invention enables partial or total miniaturization of the microscope, linked to the reduced overall size of the interferometer 6 made possible by using optical fibers. Integrating a fiber-optic interferometer 6 greatly reduces the volume of the system because replacing optical components with optical fibers eliminates the need to use mechanical supports and thus decreases the volume occupied by the arms of the interferometer.

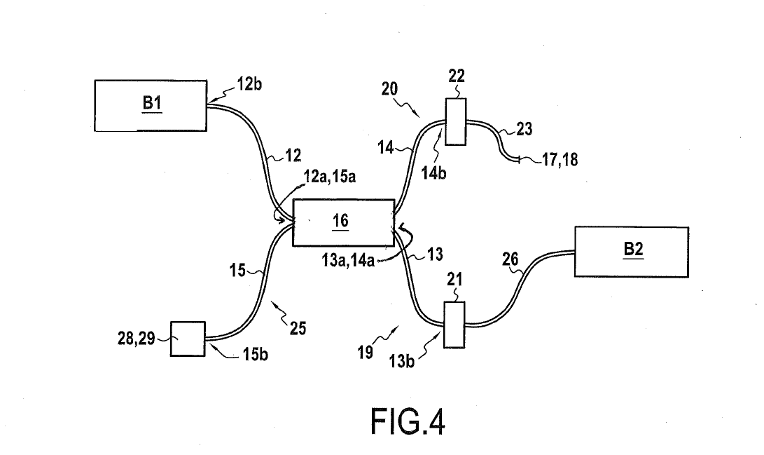

As described below and represented in FIGS. 3 and 4, using optical fibers enables replacement of the optical stage for enlarging the beam and the objective lens of the microscope by an all-fiber system or a fiber/lens system enabling surface plasmon excitation and confinement.

This part of the set-up is therefore less bulky and may be fixed to the end of the optical fiber. Thus an all-fiber microscope may be produced.

The use of optical fibers to produce the interferometer 6 of the microscope also drastically reduces the number of optical adjustments, improves the stability of the interferometer, and improves the quality of the excitation, measurement, and reference optical beams and the interferometer beam.

In a free-field interferometer as used in prior art microscopes, the beams from each arm of the interferometer must be superposed. To form the interferometer beam that is detected to form the image it is therefore necessary to align the reference and measurement beams (or to be more precise the corresponding reflected beams) and to maintain optimum superposition of those two beams over time.

The expression for the intensity of the interferometer signal collected by the detector of the free-field interferometer is written:

I=I_{ref}+Iₜₑₛₜ+2M(t)\sqrt{I_{ref}Iₜₑₛₜ}cos(2πfₘt+φ) (1)

where:
I_{ref} and Iₜₑₛₜ are the luminous intensities coming from the reference and test arms, respectively;
φ is the phase of the interference signal; and
M(t) is a factor varying in the range 0 to 1, reflecting the superposition of the two beams at the detector.

M(t) then depends on the quality of the overlapping of the two beams and consequently is a function of time t.

Thus in a free-field system continuous readjustment is required to compensate mechanical drift of the components.

In practice this entails fairly regular realignment of the apparatus, which is greatly dependent on the thermal stability of the interferometer, which can be undertaken either by the user or automatically if an automated readjustment system is introduced into the interferometer. This readjustment may be achieved, for example, by motorizing the mirror of the reference arm and a mirror upstream of the beam splitting means. A beam position readjustment loop adjusts the positions of these mirrors by either detecting the position of the beam or monitoring the optical signal itself (optimization).

In a fiber-optic configuration as proposed by the invention, the intensity of the signal derived from the interferometer beam is written:

I=I_{ref}+Iₜₑₛₜ+2M\sqrt{I_{ref}Iₜₑₛₜ}cos(2πfₘt+φ) (2)

This time M is not time-dependent. This is because interference is directly achieved in a fiber-optic interferometer by coupling within the optical fibers and consequently does not require any post-adjustment or readjustment of beam superposition.

The optical response V(z) of the microscope, where z is the defocus of the sample relative to the focus of the objective lens of the microscope, is given by the following equation:

V(z)=M\sqrt{I_{ref}Iₜₑₛₜ}cos(2πfₘt+φ) (3)

The optical signal S(x, y) of each pixel of an image produced by the surface plasmon microscope is directly proportional to the modulus of the third term of equation (2) above, i.e.:

S(x,y)=|V(z)|=M\sqrt{I_{ref}(x,y)Iₜₑₛₜ(x,y)} (4)

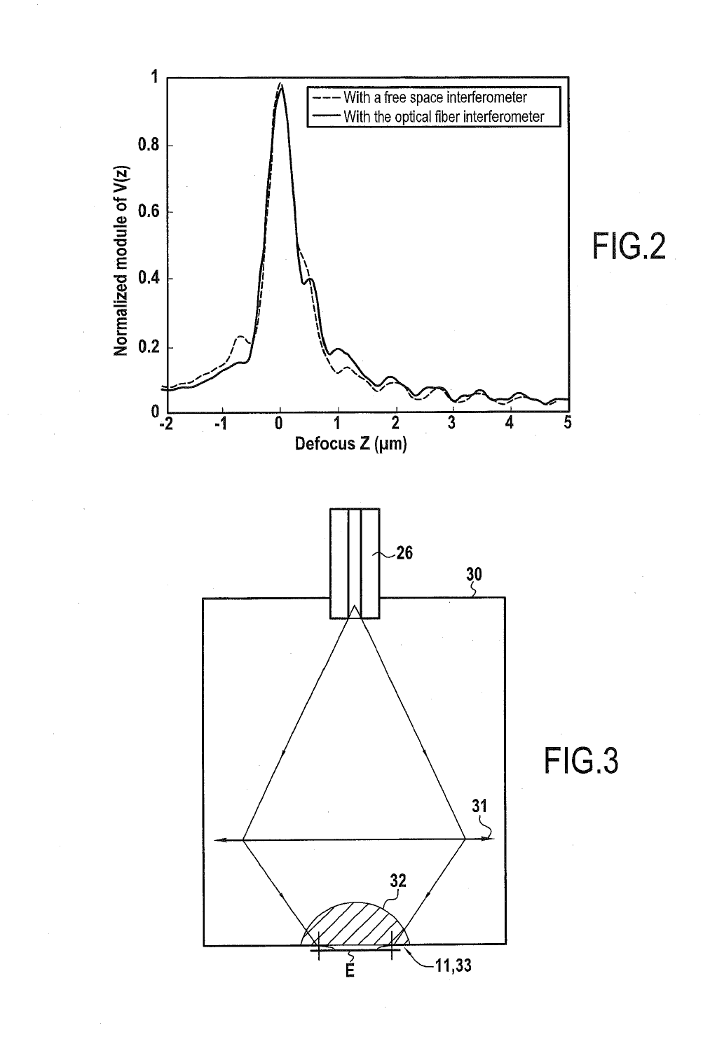

FIG. 2 shows the pertinence and performance of a heterodyne interferometer surface plasmon microscope 6 as proposed by the invention.

This FIG. 2 shows the modulus of the optical response of a surface plasmon microscope as a function of the defocus z of the objective lens of the microscope relative to the interface between the metal (gold) layer 11 covering the glass plate 10 of the optical coupling medium 7 and the observation medium (here air), the metal layer 11 having a thickness of 45 nm in this example.

As may seen in this diagram, for positive values of z oscillation occurs with a period Δz that is linked to the properties of the surface plasmon.

Comparing the response curve of the fiber-optic microscope with that of a prior art free-field microscope, it is also seen that the response of the microscope of the invention is substantially identical to that of the free-field microscope and therefore that the intensity of the response V(z) of the fiber-optic microscope is similar to that of free-field microscopes. This comparison therefore validates the fiber-optic configuration of this microscope. Furthermore, the fiber-optic system performs well with a much smaller number of photons than a free-field system. In the preferred embodiment, an increase in detection sensitivity by a factor of more than 10 has been measured, all other things being equal (laser, detector).

Moreover, the choice of a fiber-optic interferometer microscope naturally enables greater isolation of the system, rendering it less sensitive to external temperature fluctuations, acoustic and mechanical vibrations, and fluctuations in the air.

For the same reasons as indicated above, propagation of electromagnetic fields in the core of the optical fibers used ensures total superposition of those fields, eliminating fluctuations of the interferometer signal linked to fluctuations in the respective positions of the measurement and reference beams, as may be encountered with free-field microscopes.

This stability greatly increases the signal-to-noise ratio of the phase signal φ of the interferometer and facilitates fine measurements based on the phase signal by shortening the measurement integration time. Unlike free-field surface plasmon microscopes, it is therefore possible with the microscope of the invention, which uses a fiber-optic interferometer 6, to process the phase signal and obtain images of the phase of the response V(z) of the microscope. The use of the phase of the response V(z) advantageously makes it possible in particular to distinguish the nature of a sample observed using the microscope and thus to know which type of particle is being observed at a time t, for example when studying an aqueous medium containing different particles or molecules.

Finally, a singular advantage of the fiber-optic interferometer microscope of the present invention is that it enables improvement of the quality of the optical beams employed, i.e. the excitation beam, the measurement and reference beams, and the interferometer beam.

Because the light propagates in monomode optical fibers, the luminous field that propagates in the core of the fiber has a Gaussian profile as a function of the radial distance r from the center of the fiber that may be approximated as follows: φ(r)=exp(−r²/w²). The beam that reaches the objective lens of the microscope has a much more regular Gaussian function than that observed in a free-field microscope. Moreover, the light reflected by the sample E in the measurement arm 19 of the interferometer returns to the optical fiber 26 and is spatially filtered on reinjection into the fiber because it has passed through a core a few micrometers in diameter, thereby cleaning up the beam.

As mentioned above, proposed fiber-optic interferometer microscopes of particularly advantageous embodiments of the present invention are described below with reference to FIGS. 3 and 4.

A first variant of the microscope of the invention is entirely fiber-optic, from the light source to the optical coupling medium.

In this embodiment, the collimator lens 27 and the high numerical aperture objective lens 8 of the microscope from FIG. 1 are replaced by a lens doublet (block B2 in FIG. 4). The first lens of this doublet, not represented in FIG. 4, is integrated with the end of the optical fiber 26, either as a lensed fiber, meaning that the fiber end itself is machined and constitutes a diopter, or as represented in FIG. 3 in the form of an optical block 30 fixed to the end 26 of the fiber and including a first lens 31 and a solid immersion lens (SIL) type second lens 32 one plane face 33 of which serves as a glass plate and is covered with a thin layer 11 of gold that is in contact with the observation medium in which a sample to be observed is found, for example. The second lens 32 enables the measurement beam coming from the first lens 31 to be focused at the gold layer/observation medium interface to generate the surface plasmon.

This set-up has a plurality of advantages, in particular that of being much more compact than a commercial immersion objective lens as used in the FIG. 1 microscope. Moreover, the use of a lens doublet enables direct fixing to the end of the optical fiber 26 for transmitting the measurement beam, whilst offering numerical apertures higher than those of commercial objective lenses and consequently enabling observation of media with higher indices (dense polymers, liquid crystals, non-aqueous solvents, etc.). Choosing SIL with high refractive indices (greater than 2, or even higher) increases the numerical aperture.

A variant that is not represented replaces the objective lens 8 of the microscope from FIG. 1 with a fiber the end of which features an axicon. The axicon is machined directly from the end of the optical fiber to impart a conical shape to its core. An axicon enables a convergent light beam to be generated having a high angle of incidence that enables excitation of the surface plasmon.

In FIG. 4, the parts of the microscope of the invention that may optionally be fiber-optic, as required, are represented in the form of blocks B1, B2. Thus it is seen that it is equally possible, in addition to replacing the optical coupling medium of the microscope with a block B2, such as the block 30 from FIG. 3 for example, to replace the light source by an all-fiber system B1, such as a polarized fiber-optic laser for example, and conditioning the excitation light beam emitted by that source may be envisaged.

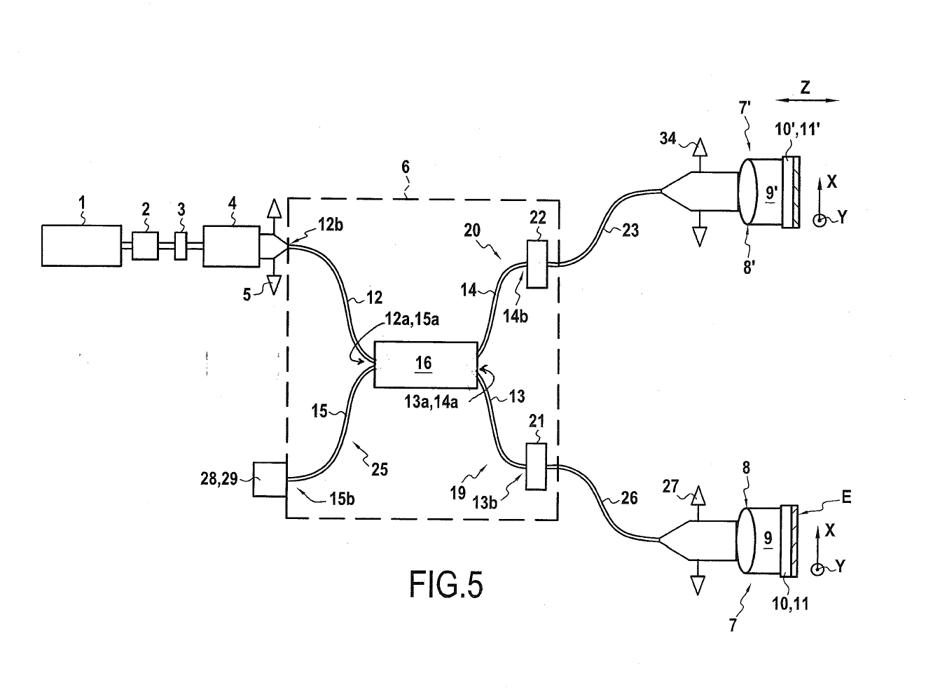

In another variant, represented in FIG. 5, the microscope of the invention includes not one but two optical coupling media 7, 7′ placed at the ends of the measurement arm 19 and the reference arm 20 of the microscope and both of identical composition, notably including an objective lens 8′, immersion oil 9′, and a glass plate 10′ covered with a gold layer 11′ of the same quality and thickness as that of the optical coupling medium 7 of the measurement arm 19. In this configuration, the reflecting element 17 of the FIG. 1 microscope is replaced by a focusing lens 34 fixed to the end of the optical fiber 23 in order to collimate the reference beam onto the objective lens 8′ of the second optical coupling medium 7′.

This particular configuration of the surface plasmon microscope, never before disclosed, enables differential surface plasmon imaging between the signal extracted from the measurement beam and the signal extracted from the reference beam, both of which signals include information linked to the surface plasmon. It is thus possible to correct the surface plasmon formed at the level of the coupling medium of the measurement arm in contact with a sample under observation by means of another reference surface plasmon, which is obtained on the same thin gold layer but this time with no contact with a sample.

This considerably increases the sensitivity of the microscope because it is possible to distinguish in the interferometer signal and the response V(z) of the microscope between noise linked to the gold layer and the surface plasmon and noise linked to the sample under observation.

Of course, in this configuration it is possible to replace both optical coupling media 7, 7′ by two lens doublets as described above and represented in FIG. 3.

In all variants of the microscope of the invention described above it is possible via the polarization converter adjoining the light source to vary at will the polarization of the excitation light beam and consequently that of the measurement, reference and interferometer beams in each of the arms of the fiber-optic heterodyne interferometer 6.

In one particular mode of use of the microscope of the invention, it is beneficial, via the polarization converter, to use the measurement beam to scan the gold layer of the optical coupling medium in lines alternately polarized in pure p mode (radial polarization) and in pure s mode (azimuth polarization). Thus in this embodiment the polarization converter is electronically controlled to switch at a chosen frequency from an azimuth polarization to a radial polarization of the excitation light beam emitted by the laser source 1 synchronously with mechanical components of movement along the axis Z of the objective lens and the axes X, Y of the optical coupling medium. If this objective lens is replaced by a lens doublet as described above with reference to FIGS. 3 and 4, it is the end 26 of the optical fiber supporting the lens pair that is replaced.

This alternate illumination of the gold layer of the optical coupling medium advantageously enables differential surface plasmon imaging, which yields images with better contrast and improved dynamic range as well as readjusting to compensate for the decrease in the response V(z) of the microscope if the defocus z increases compared to the sample.

Another use of the optical signal obtained from the beams polarized in pure s mode is to slave the vertical position of the objective lens 8 at the end of the measurement arm relative to the sample E under observation. Analysis of the signals derived from the s-polarized measurement beam reflected by the gold layer of the optical coupling medium enables determination of the absolute value of the position of the objective lens 8, and it is then possible, on the basis of that position, to correct all mechanical and thermal drift inherent to high-resolution microscopy.

This kind of technique for correcting the position of the objective lens of the microscope is not totally novel in itself in the field of microscopy, but the microscope of the invention is nevertheless especially noteworthy in that it is the imaging system itself that performs the correction and not an add-on system in parallel with the imaging system. Because of this, the microscope is not made more complex in any way and there is no major increase in the adjustment overhead, and this is achieved without interfering with the plasmon optical measurement. Moreover, this possibility of slaving the position of the objective lens 8 relative to the sample under observation enables greater accuracy in the measurement of the function V(z), both in amplitude and in phase.

Another advantage of the microscope of the present invention is enabling construction of images in three dimensions from the measured function V(z). The construction of such three-dimensional “maps” of the function V(z) enables selection of the optical section plane with the best image contrast. To this end, these 3D images are subjected to post-processing following which the plane Z with the optimum contrast is determined by interpolation.

1. A high-resolution surface plasmon microscope essentially including:
a) a coherent light source (1) adapted to emit an excitation light beam;
b) a medium (7) for optical coupling and confinement of a surface plasmon, including an objective lens (8) of large numerical aperture, immersion oil (9), and a glass plate (10) covered on a face that is not in contact with the immersion oil with a metal layer (11);
c) a heterodyne interferometer (6) for splitting the excitation light beam emitted by the light source into at least one reference beam and at least one measurement beam directed toward the coupling medium to generate a surface plasmon, the interferometer being positioned between the light source and the objective lens of the coupling medium to form an interferometer beam between the reference beam and the measurement beam after reflection of each of them by the reflecting element (17) and the metal layer (10), respectively;
d) means for scanning the metal layer with the measurement light beam;
e) means (28) for detecting the interferometer beam from the interferometer; and
f) means for processing and forming an image from the interferometer beam;
the microscope being characterized in that the heterodyne interferometer (6) consists essentially of at least four optical fibers (12, 13, 14, 15) for respectively guiding the excitation beam, the measurement beam, the reference beam, and the interferometer beam optically connected at a first of their ends (12a, 13a, 14a, 15a) to an optical coupler (16) and each also optically coupled at their second end (12b, 13b, 14b, 15b) to the light source (1), the optical coupling medium (7), the element (17) for reflecting the reference beam, and the means (28) for detecting the interferometer beam, respectively.

2. A microscope according to claim 1, characterized in that the optical fibers of the heterodyne interferometer are monomode or multimode fibers.

3. A microscope according to claim 1, characterized in that the optical fibers of the heterodyne interferometer are polarization-maintaining fibers.

4. A microscope according to claim 1, characterized in that the optical fibers (13, 14) the second ends (13b, 14b) of which are respectively connected to the element for reflecting the reference beam and to the medium for coupling and confining the surface plasmon each cooperate with at least one acousto-optical modulator (21, 22).

5. A microscope according to claim 1, characterized in that the optical fiber (12) for guiding the excitation light beam is connected at its second end (12b) to the light source (1) via at least one collimator lens (5).

6. A microscope according to claim 5, characterized in that it includes an optical isolator (2) and a half-wave plate (3) disposed between the light source (1) and the collimator lens (5).

7. A microscope according to claim 5, characterized in that it includes a polarization converter (4) positioned between the half-wave plate (3) and the collimator lens (5).

8. A microscope according to claim 1, characterized in that the fiber (13) for guiding the measurement beam is connected to the coupling medium via an optical fiber (26) and a collimator lens (27).

9. A microscope according to claim 1, characterized in that the element (17) for reflecting the reference beam is a mirror (18).

10. A microscope according to claim 9, characterized in that the mirror (18) consists of a metal coating deposited on the end of a fiber (23) connected to the end (14b) of the fiber (14) for guiding the reference beam.

11. A microscope according to claim 1, characterized in that the element (17) for reflecting the reference beam consists of the glass plate (10′) of an optical coupling medium (7′) identical to the optical coupling medium (7) connected to the fiber (13, 26) for guiding the measurement beam, said plate (10′) being coated on a face not in contact with the immersion oil (9′) with a metal layer (11′) of the same quality as that coating the glass plate (10) of the optical coupling medium connected to the fiber for guiding the measurement beam.

12. A microscope according to claim 1, characterized in that the objective lens of the optical coupling medium to which the fiber for guiding the measurement beam is connected is formed by a solid immersion lens (32) and the collimator lens (31) for the measurement beam is integrated with the end of the fiber for guiding the measurement beam, by assembly or in the form of a lensed fiber.

13. A microscope according to claim 1, characterized in that it includes an axicon formed directly at the second end of said fiber for guiding the reference beam.

14. A microscope according to claim 1, characterized in that it includes a system for scanning the metal surface of the optical coupling medium with the measurement beam.

15. microscope according to claim 1, characterized in that it includes a polarizer (29) between the means (28) for detecting the interferometer beam and the second end (15b) of the fiber (15 for guiding said interferometer beam.
